(19) United States
(12) Patent Application Publication
(10) Pub. No.: US 2019/0057247 A1
(43) Pub. Date: Feb. 21, 2019

(54) METHOD FOR AWAKENING INTELLIGENT ROBOT, AND INTELLIGENT ROBOT

(71) Applicant: YUTOU TECHNOLOGY (HANGZHOU) CO., LTD., Yuhang District Hangzhou City (CN)

(72) Inventor: Mingxiu CHEN, Yuhang District Hangzhou City (CN)

(21) Appl. No.: 16/079,272

(22) PCT Filed: Feb. 20, 2017
(86) PCT No.: PCT/CN2017/074044

§ 371 Date: Aug. 23, 2018

(30) Foreign Application Priority Data
Feb. 23, 2016 (CN) 201610098983.6

(51) Int. Cl. G06K 9/00; B25J 11/00; B25J 9/16

(52) U.S. Cl. CPC G06K 9/00248; B25J 9/1697; B25J 11/0005; G06K 9/00268

(57) ABSTRACT

A method for awakening an intelligent robot, and an intelligent robot, falling within the technical field of intelligent devices. The method comprises: step S1, acquiring image information by using an image acquisition apparatus on an intelligent robot (S1); step S2, determining whether the image information contains human face information (S2), and if not, returning back to step S1; step S3, extracting a plurality of pieces of characteristic point information on the human face information, and determining whether the human face information indicates a front human face directly facing the image acquisition apparatus according to the characteristic point information, and turning to step S4 when it is determined that the human face information indicates a front human face directly facing the image acquisition apparatus (S3); and step S4, awakening the intelligent robot, and subsequently quitting (S4). The beneficial effects of the technical solution are: being able to provide, for a user, an operation method by which an intelligent robot can be awakened without any action, reducing the operation complexity for the user to awaken the intelligent robot, improving the usage experience for the user.

### CROSS-REFERENCE TO RELATED APPLICATIONS

The present application claims priority to and the benefit of Chinese Patent Application No. CN 201610098983.6 filed on Feb. 23, 2016, the entire content of which is incorporated herein by reference.

### BACKGROUND OF THE INVENTION

### 1. Field of the Invention

The invention relates to the field of intelligent devices, especially to a method for waking up an intelligent robot and an intelligent robot.

### 2. Description of the Related Art

In the prior art, the way to operate an intelligent robot generally includes the following: 1) for intelligent robots that have input devices, commands can be input through corresponding input devices, for example, inputting control commands through an external keyboard, a touch screen of its own or other remote input device, to control the intelligent robot to perform the corresponding operation; 2) for some intelligent robots, you can control the intelligent robots by voice input, intelligent robots identify the input voice based on the built-in voice recognition model, and then perform the appropriate action; and 3) similarly, for some intelligent robots, control can be done by means of gesturing, and the intelligent robots recognize the gesture based on the built-in gesture recognition model, and then perform the appropriate action.

Based on the above-mentioned settings, in a general intelligent robot, the wake-up operation is usually performed by the above-described methods, among which the more common methods to wake up an intelligent robot are inputting specific speech utterance (for example, a user says specific sentence such as “Hi”, “Hello” to an intelligent robot), or making a specific gesture (for example, a user makes specific gestures, such as waving at hands to an intelligent robot.) to wake up the intelligent robot. However, both a gesture-based wake-up operation and a voice-based wake-up operation require the user to perform certain behavior output, and the user can not trigger the wake-up operation of the intelligent robot when there is no body movement or voice output. Thus, the operation of intelligent robots is more complex and the user experience is lowered.

### SUMMARY OF THE INVENTION

According to the problems in the prior art, there is provided technical schemes of an intelligent robot and a method for waking up an intelligent robot. The invention aims to provide a method to the user to wake up the intelligent robot without any body movement, to reduce the operation complexity of the intelligent robot for user, and to enhance the user experience.

The above technical scheme comprises:

A method for waking up an intelligent robot, wherein comprising:

step S1, using the image acquisition device on the intelligent robot to obtain image information;

step S2, judging whether or not face information exists in the image information:

If not, returning to the step S1;

step S3, extracting a plurality of feature point information on the face information, and judging whether or not the face information indicates a front face facing the image acquisition device according to the feature point information, and proceeding to step S4 when it is judged that the face information represents the front face; and

step S4, waking up the intelligent robot, and then exiting.

Preferably, the method for waking up an intelligent robot, wherein in the step S2, a face detector is used to determine whether or not the face information is present in the image information.

Preferably, the method for waking up an intelligent robot, wherein in the step S2, if it is determined that the face information is present in the image information, the position information and the size information associated with the face information are acquired;

wherein, the step S3 specifically comprises:

step S31, extracting a plurality of feature points in the face information based on the position information and the size information by using a feature point prediction model formed in advance training;

step S32, judging information of each part outline in the face information according to the plurality of feature point information;

step S33, obtaining a first distance from the center point of the nose to the center point of the left eye in the face information and a second distance from the center point of the nose to the center point of the right eye; and

step S34, judging whether the difference between the first distance and the second distance is included within a preset difference range:

if yes, judging that the face information represents the front face, and then proceeding to the step S4;

if not, judging that the face information does not represent the front face, and then returning to the step S1.

Preferably, the method for waking up an intelligent robot, wherein after the step S3 is executed, if it is determined that the face information includes the front face, first executing a dwell time judging step, and then executing the step S4;

wherein, the dwell time judging step specifically comprises:

step A1, continuously tracking and capturing the face information, and recording the duration of stay of the front face;

step A2, judging whether or not the duration of stay of the front face exceeds a preset first threshold value:

if yes, the process proceeds to step S4;

if not, the process returns to step S1.

Preferably, the method for waking up an intelligent robot, wherein in the step S2, if it is determined that the face information is present in the image information, the position information and the size information associated with the face information is recorded;

after executing the step A2, if it is judged that the duration of the front face is more than the first threshold value, first executing a distance judging step, and then executing the step S4;

wherein, the distance judging step specifically comprises:

step B1, judging whether the size information is not less than a preset second threshold value:

if yes, the process proceeds to step S4;

if not, the process returns to step S1.

Preferably, the method for waking up an intelligent robot, wherein in the step S2, if it is determined that the face information is present in the image information, the position information and the size information associated with the face information is recorded;

after executing the step S3, if it is judged that the face information includes the front face, first executing a distance judging step, and then executing the step S4;

wherein, the distance judging step specifically comprises:

step B1, judging whether the size information is not less than a preset second threshold value:

if yes, the process proceeds to step S4;

if not, the process returns to step S1.

Preferably, the method for waking up an intelligent robot, wherein after executing the step B1, if it is judged that the size information is not smaller than the second threshold value, first executing a dwell time judging step, and then executing the step S4:

wherein, the dwell time judging step specifically comprises:

step A1, continuously tracking and capturing the face information, and recording the duration of stay of the front face;

step A2, judging whether or not the duration of stay of the front face exceeds a preset first threshold value:

if yes, the process proceeds to step S4;

if not, the process returns to step S1.

Preferably, the method forwaking up an intelligent robot, wherein the first threshold is 2 seconds.

Preferably, the method for waking up an intelligent robot, wherein the second threshold is 400 pixels.

An intelligent robot, wherein using the above-mentioned method for waking up the intelligent robot.

The technical schemes have the beneficial effects that: provides a method for waking up an intelligent robot, which can provide an operation method to the user to wake up the intelligent robot without any body movement, and reduce the operation complexity of the user to wake up the intelligent robot and enhance the user's experience.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 is a general flow diagram of a method for waking up an intelligent robot in a preferred embodiment of the present invention;

FIG. 2 is a step schematic diagram of judging whether or not face information represents a front face in a preferred embodiment of the present invention;

FIG. 3 is a flow schematic diagram of a method for waking up an intelligent robot comprising a dwell time judging step in a preferred embodiment of the present invention;

FIGS. 4-5 are flow schematic diagrams of a method for waking up an intelligent robot comprising a dwell time judging step and a distance judging step in a preferred embodiment of the present invention;

FIG. 6 is a flow schematic diagram of a method for waking up an intelligent robot comprising a distance judging step in a preferred embodiment of the present invention.

### DETAILED DESCRIPTIONS

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

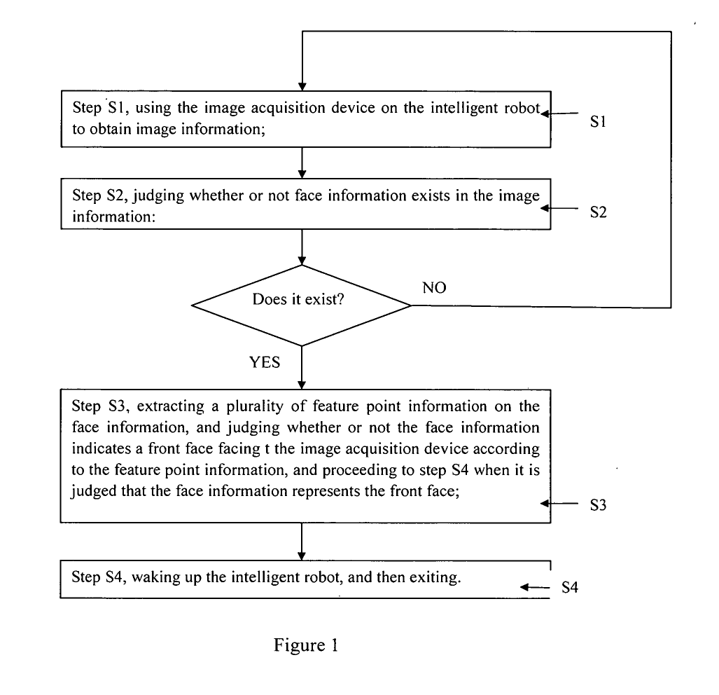

In a preferred embodiment of the present invention, based on the above-mentioned problems in the prior art, there is provided a method for waking up an intelligent robot, comprising the following steps as described in FIG. 1:

step S1, using the image acquisition device on the intelligent robot to obtain image information;

step S2, judging whether or not face information exists in the image information:

If not, the process returns to step S1;

step S3, extracting a plurality of feature point information on the face information, and judging whether or not the face information indicates a front face facing the image acquisition device according to the feature point information, and proceeding to step S4 when it is judged that the face information represents the front face; and

step S4, waking up the intelligent robot, and then exiting.

In a specific embodiment, in the above-described step S1, the so-called image acquisition device may be a camera provided on an intelligent robot, that is, a camera provided on the intelligent robot tries to acquire the image information located in its capturing area.

Subsequently, it is judged whether or not face information exists in the acquired image information according to a certain judgment rule. Specifically, a face detector formed by training in advance can be used to determine whether or not face information exists in the above-described image information. The so-called face detector can actually be a pre-trained face detection model, which can do repeated learning and form the detection model by a plurality of face training samples which are input in advance, and the detection model is applied to the actual image information detection to detect whether or not face information for representing the face is included in the image information. In this step, the face information may include face information representing a front face, and may also include face information representing a side face or a part of the face, and these detection standards can be realized by controlling the generation content of the face detector by the previously inputted training samples. The process of forming a face detector by repeatedly learning of a training sample has existed in the prior art, and will not be described in detail herein.

In this embodiment, if it is judged that face information is not present in the image information, the process returns to the above step S1 to continue to acquire the image information using the image acquisition device; if it is judged that the face information is present in the image information, the process proceeds to step S3. In step S3 described above, it is determined whether or not the face information represents a front face facing the image acquisition device by extracting a plurality of feature point information in the face information: if yes, proceeding to step S4 to wake up the intelligent robot based on the detected front face (i.e., judging that the user intends to operate the intelligent robot at this time); if not, the process returns to step S1 to continue the acquisition of the image information using the image acquisition device and continues the determination of the face information.

In conclusion, the technical scheme of the present invention provides a way that a user is able to wake up and operate the intelligent robot by directly facing the image acquisition device (for example, camera) of the intelligent robot, and avoid the conventional problem that voice or gestures must be input to carry out the wake-up operation of the intelligent robot.

In the preferred embodiment of the present invention, in step S2, if it is judged that the face information is present in the image information, the position information and the size information associated with the face information is acquired;

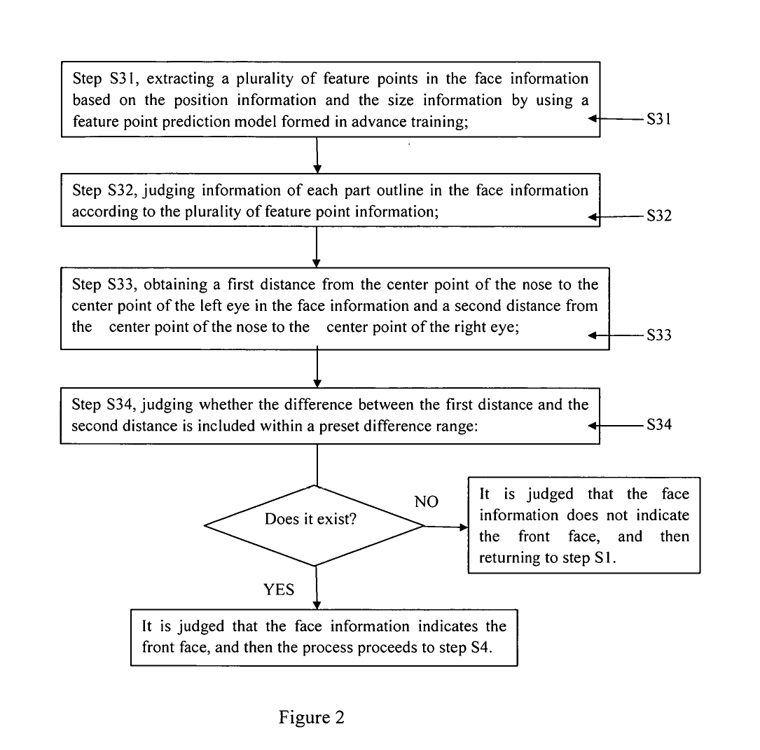

The above-described step S3 is specifically as shown in FIG. 2, comprising:

step S31, using the feature point prediction model formed in advance training, extracting a plurality of feature points in the face information based on the position information and the size information;

step S32, determining the information of each part outline in the face information according to the plurality of feature point information;

step S33, obtaining the first distance from the center point of the nose to the center point of the left eye in the face information and the second distance from the center point of the nose to the center point of the right eye; and

Step S34, judging whether or not the difference between the first distance and the second distance is included within a preset difference value range:

if yes, judging that the face information indicates the front face, and then the process proceeds to step S4;

if not, judging that the face information does not indicate the front face, and then the process returns to step S1.

Specifically, in a preferred embodiment of the present invention, in the step S2, when it is judged that the face information is present in the obtained image information, the position information and the size information of the face information is obtained while obtaining the face information.

The position information refers to the position where the face represented by the face information is located in the image information, for example, in the center of the image, in the upper left of the image, or in the lower right of the image, etc.

The size information refers to the size of the face represented by the face information, and is usually expressed in pixels.

The above-described steps S31 to S32 first extract a plurality of feature points in the face information from the positional information and the size information associated with the face information by using the feature point prediction model formed in advance training, and then the information of each part outline in the face information is determined according to the extracted feature points. Also, the so-called feature point prediction model can be the forecast model formed through input and learning of a plurality of training samples in advance, by extracting and predicting the 68 feature points in the human face, and obtain the contours of the eyebrows, eyes, nose, mouth and face as a whole to outline the outline of human face.

Subsequently, in a preferred embodiment of the present invention, in the step S33, the position of the center point of the nose, the position of the center point of the left eye, and the position of the center point of the right eye are respectively obtained based on the outline information, and then calculating the distance between the position of the center point of the nose and the position of the center point of the left eye as the first distance, and calculating the distance between the position of the center point of the nose and the position of the center point of the right eye as a second distance. The difference between the first distance and the second distance is then calculated and it is determined whether the difference is within a preset difference range: if so, the face information indicates that the front face facing the image acquisition device of the intelligent robot; if not, the face information indicates that the face is not a front face.

In particular, in a preferred embodiment of the present invention, the distance from the center point of the nose to the center point of the left and right eyes should be equal or close to each other due to the symmetry of the human face for the front face. And if the face turns side slightly, the distance between the two will inevitably change, such as face turns left, the distance from the center point of the nose to the center point of the right eye is inevitably reduced, so that the difference between the above two distances increases. Similarly, if the face turns right, the distance between the center of the nose to the center of the left eye will be reduced, so that the difference between the two distances will also increase.

Therefore, as described above, in the most ideal case, if the face information represents a front face, the above two distances should be equal, that is, the difference between the above two distances should be zero. However, in reality, the face cannot be absolutely symmetric, so in the case of face information that represents the front face, the distance between the two will still have a certain difference, but the difference should be smaller. Therefore, in a preferred embodiment of the present invention, the above-mentioned difference value range should be set to a suitable small value range to ensure that it can be judged that whether or not the face information represents the front face through the difference value range.

In a preferred embodiment of the present invention, after performing step S3 described above, if it is judged that the face information includes the front face, a dwell time judging step is executed first, followed by step S4,

wherein, the dwell time judging step specifically comprises:

step A1, continuously tracking and capturing face information, and recording the duration of stay of the front face;

step A2, judging whether the duration of stay of the front face exceeds a preset first threshold value:

if yes, the process proceeds to step S4;

if not, the process returns to step S1.

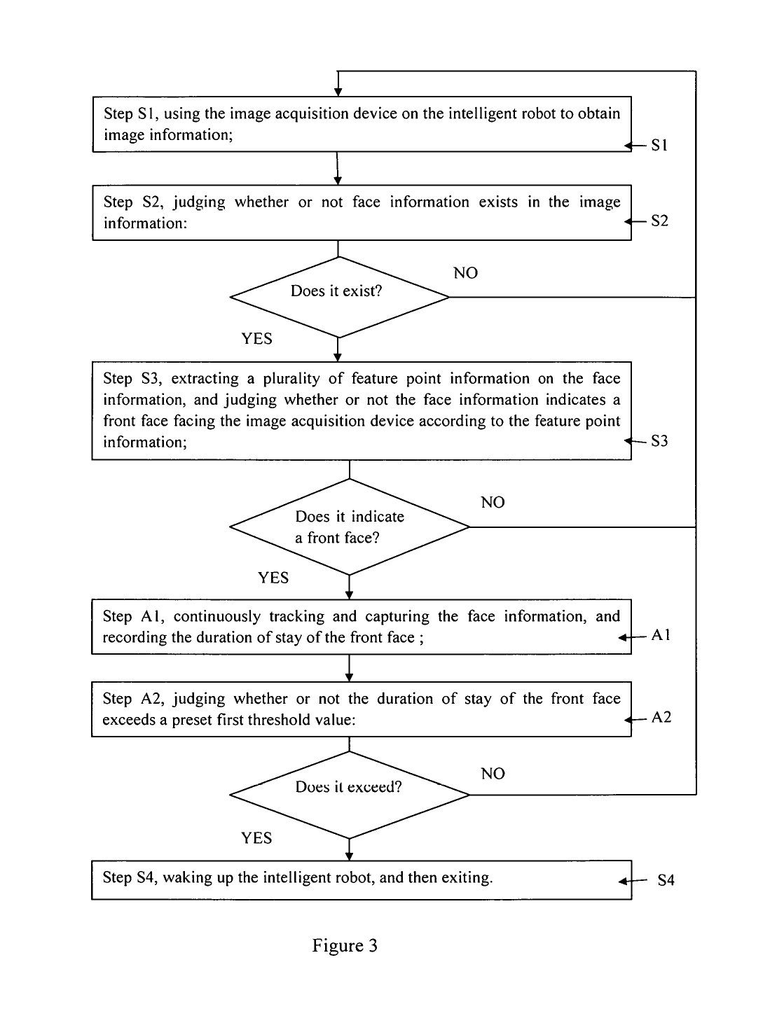

In a preferred embodiment of the present invention, the process of the entire wake-up method including the above-described dwell time judging step is as shown in FIG. 3, comprising:

step S1, using the image acquisition device on the intelligent robot to obtain image information;

step S2, judging whether or not face information exists in the image information:

if not, the process returns to step S1;

step S3, extracting a plurality of feature point information on the face information, and judging whether or not the face information indicates a front face facing the image acquisition device according to the feature point information:

If not, the process returns to step S1;

step A1, continuously tracking and capturing face information, and recording the duration of stay of the front face;

step A2, judging whether the duration of stay of the front face exceeds a preset first threshold value:

if yes, the process proceeds to step S4;

if not, the process returns to step S1.

step S4, waking up the intelligent robot, and then exiting.

Specifically, in this embodiment, in the above-described process, the step of making a judgment on the front face as described above is performed first. When it is judged that the currently identified face information indicates the front face, executing the dwell time judging step, that is to keep track of the acquisition of the face information, and continuously compares the current face information with the face information of the previous moment to judge whether or not the face information representing the front face is changed, finally, recording the duration of the face information which is not changed, i.e., the duration of stay of the face information.

In this embodiment, for the comparison of the face information described above, a contrast difference range may be set to allow the face information to be changed in a minute range.

In this embodiment, the dwell time judging step is applied to the whole wake-up method, and is referred to as the step (as shown in FIG. 3) as described above: the step of judging the front face is performed first, and when the current face information is judged to represent the front face, the dwell time judging step is performed. Only when both the front face judgment criteria and dwell time criteria are met, can it be considered to wake up the intelligent robot.

In a preferred embodiment of the invention, the preset first threshold value described above may be set to a normal reaction time such as when a person is staring, for example, may be set to 1 second, or 2 seconds.

In a preferred embodiment of the present invention, as described above, in step S2, if it is judged that the face information is present in the image information, the position information and the size information associated with the face information is recorded.

The wake-up method further comprises a distance judging step. This step relies on the above-described recorded position information and size information. Specific can be:

step B1, judging whether the size information is not less than a preset second threshold value:

if yes, the process proceeds to step S4;

if not, the process returns to step S1.

Specifically, in a preferred embodiment of the present invention, the above-mentioned distance judging step functions to determine whether or not the face is close to the image acquisition device (camera): If yes, it is judged that the user consciously wakes up the intelligent robot; If not, it is judged that the user does not want to wake up the intelligent robot.

In a preferred embodiment of the present invention, the second threshold value may be a value suitable for the size of the finder frame of the image acquisition device. For example, the finder frame size is usually 640 pixels, and the second threshold value may be set to 400 pixels, therefore, if the size information associated with the face information is not smaller than the second threshold value (i.e., the face size is not smaller than 400 pixels), it is considered that the user is closer to the image acquisition device at this time, otherwise, the user is considered to be farther from the image acquisition device.

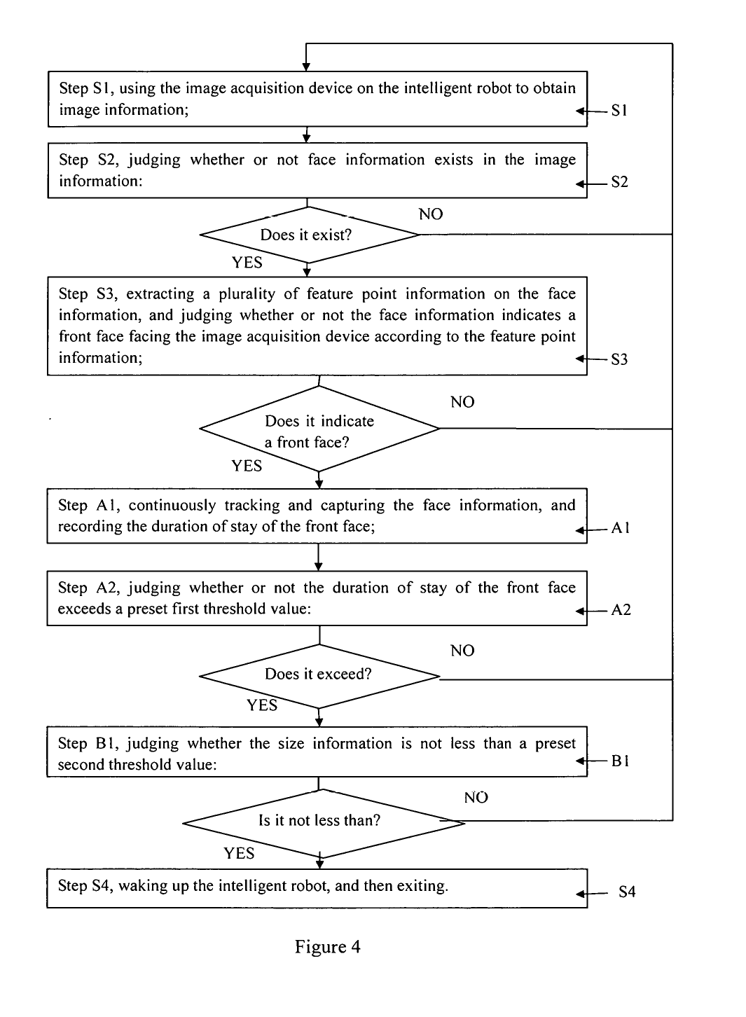

In a preferred embodiment of the present invention, the above-mentioned dwell time judging step and the distance judging step are simultaneously applied to the wake-up method described above, and the final formed process is as shown in FIG. 4, comprising:

step S1, using the image acquisition device on the intelligent robot to obtain image information;

step S2, judging whether or not face information exists in the image information:

if not, the process returns to step S1;

step S3, extracting a plurality of feature point information on the face information, and judging whether or not the face information indicates a face facing the front face of the image acquisition device according to the feature point information:

If not, the process returns to step S1;

step A1, continuously tracking and capturing face information, and recording the duration of stay of the front face;

step A2, judging whether the duration of stay of the front face exceeds a preset first threshold value:

if not, the process returns to step S1.

Step B1, judging whether the size information is not less than a preset second threshold value:

if yes, the process proceeds to step S4;

if not, the process returns to step S1.

Step S4, waking up the intelligent robot, and then exiting.

In this embodiment, the order of determination is as follows: judging whether or not face information exists in the image→judging whether or not the face information indicates the front face→judging whether the residence time of the face information conforms to the standard→judging whether or not the size information associated with the face information conforms to the standard.

Therefore, in this embodiment, it is considered that the user wishes to wake up the intelligent robot only when the following three conditions are satisfied simultaneously, and actually performs the operation of waking up the intelligent robot according to the judgment result:
(1) Face information represents a front face;
(2) The sustained dwell time of the face exceeds the first threshold;
(3) The size of the face in the view frame is not less than the second threshold value.

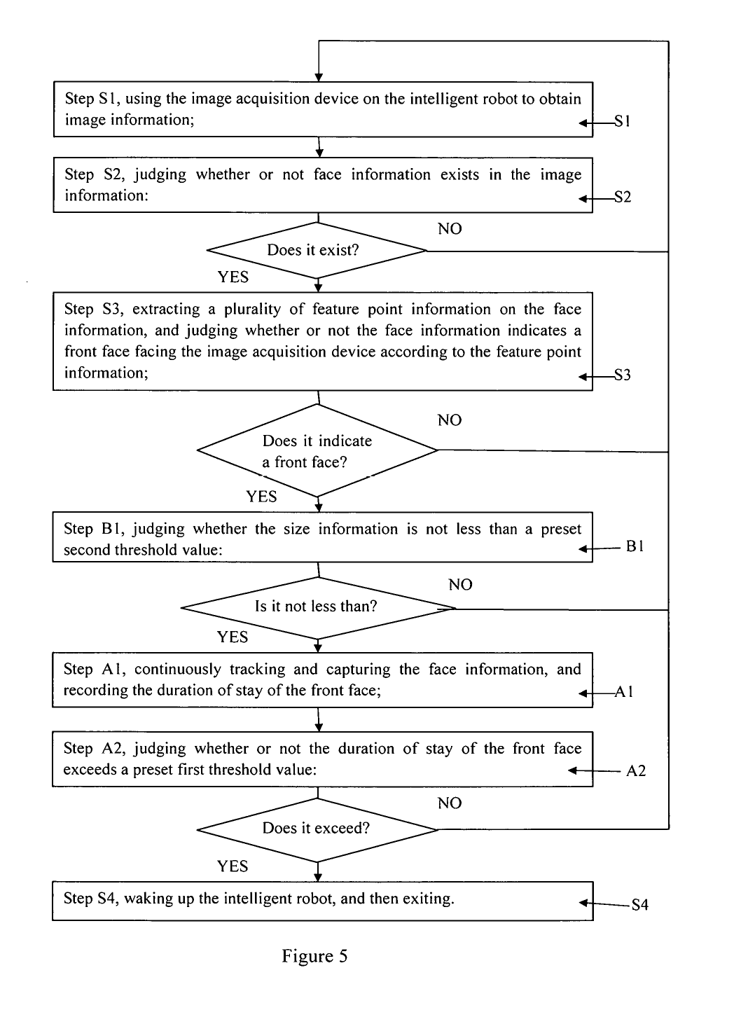

In a further preferred embodiment of the present invention, similarly, the process of the complete wake-up method formed by simultaneously applying the dwell time determination step and the distance judging step is as shown in FIG. 5, comprising:

step S1, using the image acquisition device on the intelligent robot to obtain image information;

step S2, judging whether or not face information exists in the image information:

if not, the process returns to step S1;

step S3, extracting a plurality of feature point information on the face information, and judging whether or not the face information indicates a front face facing the image acquisition device according to the feature point information:

if not, the process returns to step S1;

step B1, judging whether the size information is not less than a preset second threshold value:

if not, the process returns to step S1;

step A1, continuously tracking and capturing the face information, and recording the duration of stay of the front face;

Step A2, judging whether the duration of stay of the front face exceeds a preset first threshold value:

if yes, the process proceeds to step S4;

if not, the process returns to step S1;

step S4, waking up the intelligent robot, and then exiting.

In this embodiment, the specific judging process is: judging whether or not face information exists in the image→judging whether or not the face information indicates the front face→judging whether or not the size information associated with the face information conforms to the standard→judging whether the residence time of the face information conforms to the standard. Likewise, in this embodiment, it is necessary to meet three conditions simultaneously in order to be considered to be capable of performing the intelligent robot wake-up operation.

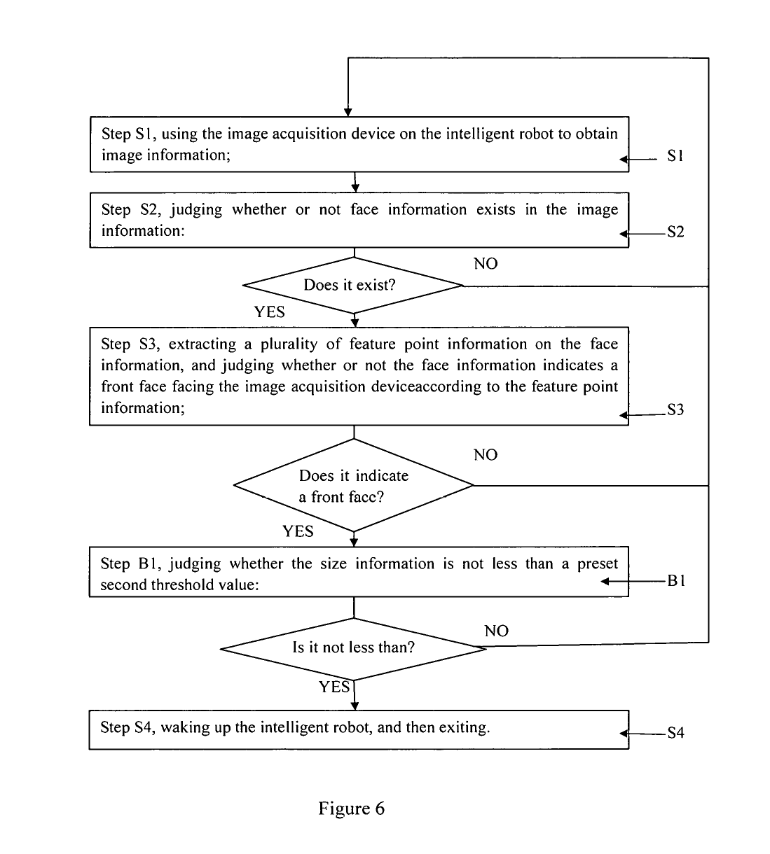

In another preferred embodiment of the present invention, only the distance judging step may be added to the wake-up method, as shown in FIG. 6, comprising:

step S1, using the image acquisition device on the intelligent robot to obtain image information;

step S2, judging whether or not face information exists in the image information:

if not, returns to the step S1;

step S3, extracting a plurality of feature point information on the face information, and judging whether or not the face information indicates a front face facing the image acquisition device according to the feature point information:

if not, the process returns to step S1;

step B1, judging whether the size information is not less than a preset second threshold value:

if yes, the process proceeds to step S4;

if not, the process returns to step S1;

step S4, waking up the intelligent robot, and then exiting.

In this embodiment, it is only necessary to satisfy both conditions, namely (1) the face information represents the front face; (2) the size of the face in the view frame is not less than the second threshold value; then it can be considered that the user wakes up the intelligent robot consciously and performs a wake-up operation on the intelligent robot based on the judgment result.

In conclusion, in the technical solution of the present invention, three conditions for judging whether or not to execute the wake-up operation of the intelligent robot are provided: (1) face information represents the front face; (2) the persistent dwell time of the face exceeds the first threshold value; (3) the size of the face in the view frame is not less than the second threshold value. Each judgment condition has its corresponding judgment process, of which, the (1) judgment condition is necessary for the wake-up method of the present invention, while the latter (2) and (3) judging conditions are only optional judging conditions for the wake-up method of the present invention, and thus a variety of wake-up methods can be derived. These derived wake-up methods and modifications and updates in accordance with these wake-up methods should be included within the scope of the present invention.

In a preferred embodiment of the present invention, there is also provided an intelligent robot in which the method for waking up an intelligent robot described above is employed.

The above description is only the preferred embodiments of the invention, not thus limiting the embodiments and scope of the invention. Those skilled in the art should be able to realize that the schemes of equivalent substitution and obvious variation obtained from the content of specification and drawings of the invention should fall into the scope of the invention.

What is claimed is:

1. A method for waking up an intelligent robot, comprising:
Step S1, using the image acquisition device on the intelligent robot to obtain image information;
Step S2, judging whether or not face information exists in the image information:
if not, returning to the Step S1;
Step S3, extracting a plurality of feature point information on the face information, and judging whether or not the face information indicates a front face facing towards the image acquisition device according to the feature point information, and proceeding to Step S4 when it is judged that the face information represents the front face; and
Step S4, waking up the intelligent robot, and then exiting.

2. The method for waking up an intelligent robot as claimed in claim 1, wherein in Step S2, a face detector is used to judge whether or not the face information exists in the image information.

3. The method for waking up an intelligent robot as claimed in claim 1, wherein in Step S2, if it is judged that the face information exists in the image information, acquiring position information and size information associated with the face information;
wherein, Step S3 specifically comprises:
Step S31, extracting the plurality of feature points in the face information based on the position information and the size information by using a feature point prediction model formed in an advance training;
Step S32, judging information of each part outline in the face information according to the plurality of feature point information;
Step S33, obtaining a first distance from a center point of a nose to a center point of a left eye in the face information and a second distance from the center point of the nose to a center point of a right eye; and
Step S34, judging whether a difference between the first distance and the second distance is included within a preset difference range:
if yes, judging that the face information represents the front face, and then proceeding to Step S4;
if not, judging that the face information does not represent the front face, and then returning to Step S1.

4. The method for waking up an intelligent robot as claimed in claim 1, wherein after execution of Step S3, if it is judged that the face information represents the front face, performing a dwell time judging step first, and then executing Step S4;
wherein, the dwell time judging step specifically comprises:
Step A1, continuously tracking and capturing the face information, and recording a duration of stay of the front face;
Step A2, judging whether or not the duration of stay of the front face exceeds a preset first threshold value:
if yes, turning to Step S4;
if not, returning to Step S1.

5. The method for waking up an intelligent robot as claimed in claim 4, wherein in Step S2, if it is judged that the face information exists in the image information, the position information and the size information associated with the face information is recorded;
after execution of Step A2, if it is judged that the duration of stay of the front face is more than the first threshold value, executing a distance judging step first, and then executing Step S4;
wherein, the distance judging step specifically comprises:
Step B1, judging whether the size information is not less than a preset second threshold value:
if yes, turning to Step S4;
if not, returning to Step S1.

6. The method for waking up an intelligent robot as claimed in claim 1, wherein in Step S2, if it is judged that the face information exists in the image information, the position information and the size information associated with the face information is recorded;
after execution of Step S3, if it is judged that the face information represents the front face, executing a distance judging step first, and then executing Step S4;
wherein, the distance judging step specifically comprises:
Step B1, judging whether a value of the size information is not less than a preset second threshold value:
if yes, turning to Step S4;
if not, returning to Step S1.

7. The method for waking up an intelligent robot as claimed in claim 6, wherein after execution of Step B1, if it is judged that a value of the size information is not less than the second threshold value, executing a dwell time judging step first, and then executing Step S4:
wherein, the dwell time judging step specifically comprises:
Step A1, continuously tracking and capturing the face information, and recording a duration of stay of the front face;
Step A2, judging whether or not the duration of stay of the front face exceeds a preset first threshold value;
if yes, turning to Step S4;
if not, returning to Step S1.

8. The method for waking up an intelligent robot as claimed in claim 4, wherein the first threshold is 2 seconds.

9. The method for waking up an intelligent robot as claimed in claim 7, wherein the first threshold is 2 seconds.

10. The method for waking up an intelligent robot as claimed in claim 5, wherein the second threshold is 400 pixels.

11. The method for waking up an intelligent robot as claimed in claim 6, wherein the second threshold is 400 pixels.

12. An intelligent robot, using a method for waking up the intelligent robot, the method comprising:
Step S1, using the image acquisition device on the intelligent robot to obtain image information;
Step S2, judging whether or not face information exists in the image information:
if not, returning to the Step S1;
Step S3, extracting a plurality of feature point information on the face information, and judging whether or not the face information indicates a front face facing towards the image acquisition device according to the feature point information, and proceeding to Step S4 when it is judged that the face information represents the front face; and
Step S4, waking up the intelligent robot, and then exiting.

13. The intelligent robot as claimed in claim 12, wherein in Step S2, a face detector is used to judge whether or not the face information exists in the image information.

14. The intelligent robot as claimed in claim 12, wherein in Step S2, if it is judged that the face information exists in the image information, acquiring position information and size information associated with the face information;
wherein, Step S3 specifically comprises:
Step S31, extracting the plurality of feature points in the face information based on the position information and the size information by using a feature point prediction model formed in an advance training;
Step S32, judging information of each part outline in the face information according to the plurality of feature point information;
Step S33, obtaining a first distance from a center point of a nose to a center point of a left eye in the face information and a second distance from the center point of the nose to a center point of a right eye; and
Step S34, judging whether a difference between the first distance and the second distance is included within a preset difference range:
if yes, judging that the face information represents the front face, and then proceeding to Step S4;
if not, judging that the face information does not represent the front face, and then returning to Step S1.

15. The intelligent robot as claimed in claim 12, wherein after execution of Step S3, if it is judged that the face information represents the front face, performing a dwell time judging step first, and then executing Step S4;
wherein, the dwell time judging step specifically comprises:
Step A1, continuously tracking and capturing the face information, and recording a duration of stay of the front face;
Step A2, judging whether or not the duration of stay of the front face exceeds a preset first threshold value:
if yes, turning to Step S4;
if not, returning to Step S1.

16. The intelligent robot as claimed in claim 15, wherein in Step S2, if it is judged that the face information exists in the image information, the position information and the size information associated with the face information is recorded;
after execution of Step A2, if it is judged that the duration of stay of the front face is more than the first threshold value, executing a distance judging step first, and then executing Step S4;
wherein, the distance judging step specifically comprises:
Step B1, judging whether the size information is not less than a preset second threshold value:
if yes, turning to Step S4;
if not, returning to Step S1.

17. The intelligent robot as claimed in claim 12, wherein in Step S2, if it is judged that the face information exists in the image information, the position information and the size information associated with the face information is recorded;
after execution of Step S3, if it is judged that the face information represents the front face, executing a distance judging step first, and then executing Step S4;
wherein, the distance judging step specifically comprises:
Step B1, judging whether a value of the size information is not less than a preset second threshold value:
if yes, turning to Step S4;
if not, returning to Step S1.

18. The intelligent robot as claimed in claim 17, wherein after execution of Step B1, if it is judged that a value of the size information is not less than the second threshold value, executing a dwell time judging step first, and then executing Step S4:
wherein, the dwell time judging step specifically comprises:
Step A1, continuously tracking and capturing the face information, and recording a duration of stay of the front face;
Step A2, judging whether or not the duration of stay of the front face exceeds a preset first threshold value;
if yes, turning to Step S4;
if not, returning to Step S1.

19. The intelligent robot as claimed in claim 18, wherein the first threshold is 2 seconds.

20. The intelligent robot as claimed in claim 17, wherein the second threshold is 400 pixels.
